(19) United States
(12) Patent Application Publication
(10) Pub. No.: US 2008/0224848 A1
(43) Pub. Date: Sep. 18, 2008

(54) Apparatus and Method For Alarm Detection and Notification

(76) Inventor: Miles Meyer, Madison, WI (US)

Correspondence Address: BOYLE FREDRICKSON S.C., 840 North Plankinton Avenue, MILWAUKEE, WI, 53203, US

(21) Appl. No.: 11/687,388

(22) Filed: Mar. 16, 2007

(51) Int. Cl. G08B 23/00

(52) U.S. Cl. 340/517

(57) ABSTRACT

A device for detecting the presence of an alarm condition and automatically dialing a preprogrammed telephone number is described. The device comprises a standard telephone configured to house a detection sensor. The telephone includes an interface that couples the detection sensor to the telephone so that upon detection of an alarm event. The interface relays a signal from the sensor to the telephone. The telephone then waits a predetermined amount of time prior to initiating a telephone call to a predetermined telephone number to alert a person at the predetermined telephone number of the alarm condition.

### BACKGROUND OF THE INVENTION

1. Field of the Invention

The present invention relates in general to a telephone-based alarm system. More particularly, the present invention relates to a telephone configured to detect the presence of smoke and carbon monoxide. Specifically, a preferred embodiment of the present invention relates to a telephone configured to detect the presence of smoke or carbon monoxide and to automatically dial a preprogrammed number in response to the detection of one of smoke and carbon monoxide.

2. Discussion of the Related Art

Historically, it was known in the prior art to send alarm condition notifications by telephone line. However, such devices often require special in-home equipment and the enlistment of a third-party monitoring service. In addition, some of the previous devices of the kind known in the art, suffer from the disadvantage that the device cannot independently operate as a standard telephone. Furthermore, such devices commonly do not allow a user to preprogram a desired telephone number to be dialed in the event of an emergency; rather, such devices typically require that a monitoring station or the like be called in the event of alarm detection. Additionally, some prior art devices of the kind known in the art have not provided for the ability to detect both smoke and carbon monoxide in one, self-contained device.

Needless to say, it is desirable to provide a device that is capable of monitoring for the presence of both smoke and carbon monoxide and automatically dialing a preprogrammed number, e.g., 9-1-1, upon detection of the presence of either smoke or carbon monoxide. In addition, it is desirable to provide a plug-and-play telephone device that includes a self-contained smoke and carbon monoxide detection sensor. Furthermore, it is desirable to provide a telephone device that does not require the use of a third-party monitoring service.

The disclosures of the below-referenced United States patents and applications in their entireties are hereby expressly incorporated by reference into the present application for purposes including, but not limited to, indicating the background of the present invention and illustrating the state of the art.

U.S. Pat. No. 5,283,816 discloses a smoke detector or fire detector unit that has a built in telephone dial-pad and has the capability of connecting with a phone line and dialing the last number entered by a user. If smoke or fire is detected, the unit uses the phone line to dial the preset number and then transmit either coded information or a prerecorded message. However, the unit has no voice capabilities and cannot be used in the course of an ordinary telephone conversation.

U.S. Pat. No. 5,365,568 discloses a smoke detector configured to automatically alert a monitoring station upon the detection of the presence of an alarm condition. The device disclosed therein requires the use of a third-party monitoring service.

In embodiments disclosed in the above-referenced patents, devices for automatically sending notification of the presence of an alarm condition by telephone are disclosed. As indicated above, such devices have the disadvantage that they may require the enlistment of a third party monitoring service, which charges a fee for the service. Further, as indicated above, such devices may also have the disadvantage that they cannot operate independently as telephones. Furthermore, the above referenced devices suffer the disadvantage that they do not allow the user to independently preset the telephone number to be dialed in the event of alarm detection.

### SUMMARY AND OBJECTS OF THE INVENTION

By way of summary, the present invention is directed to a device configured for monitoring and detecting the presence of smoke and carbon monoxide and automatically dialing a preprogrammed telephone number, e.g., 9-1-1 in response to such detection. The present invention does not require the enlistment of a third-party monitoring service, but rather, allows the user to preprogram the desired telephone number.

It is another object of the present invention to provide a telephone that may be used as an ordinary telephone in the absence of any alarm condition so that the user may make and receive telephone calls.

According to one embodiment of the present invention, a telephone is fitted with a smoke and carbon monoxide detection sensor inside the telephone housing. Upon detection of the presence of smoke and/or carbon monoxide, after a preset time delay, the phone initiates a telephone call to a preprogrammed telephone number, e.g., 9-1-1. In addition, the device may be configured to transmit a prerecorded message over the telephone line. Furthermore, the device may provide a means for canceling the alarm notification in the instance where a false alarm has been created.

It is another object of the present invention to audibly announce the detection of an alarm event. A speaker or the like may be provided in the device for this purpose. The device may be configured to audibly indicate the presence of a particular alarm condition through a prerecorded message announced through the speaker of the device. In addition, a visual indication of the presence of an alarm event may be provided through the use of, for example, an LED on the outside surface of the device.

It is still another object of the present invention to provide for a means of automatically terminating the alarm notification telephone call after a predetermined period of time. The period of time may be predetermined or programmed by the user. In this embodiment, emergency responders can be directed to, e.g., the fire, using emergency system location means, such as a caller ID system that also lists an address

It is yet another object of one embodiment of the present invention to provide a cellular telephone that includes a means for monitoring and detecting the presence of a fire, e.g., by detecting smoke and carbon monoxide and automatically dialing a preprogrammed telephone number in response to the detection. In another embodiment, the use of a cellular telephone will enable the user to take the device anywhere the user goes for the purposes of detecting the presence of smoke or carbon monoxide.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a perspective view according to one embodiment of the present invention;

FIG. 2 illustrates a cross sectional view of the according to one embodiment of the present invention;

FIG. 3 illustrates a flow chart depicting one embodiment of the present invention.

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents, which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

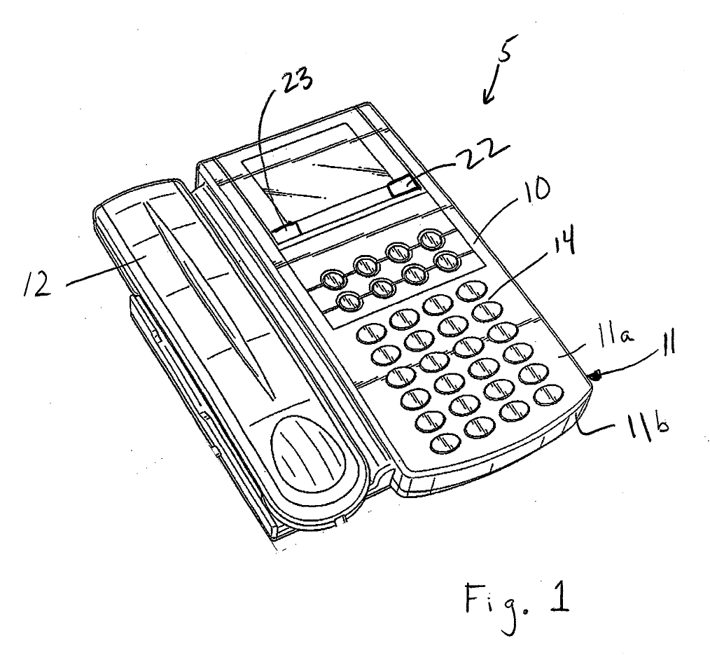

Referring to FIG. 1, the inventive device 5 is preferably a device for sending or transmitting alarm messages, e.g., a modified conventional telephone 10. The telephone 10 is preferably configured for making and receiving telephone calls, and thus it comprises a receiver/transmitter 12 and a dial pad 14 operably coupled to a housing 11 having a top 11a and a bottom 11b.

In one embodiment, the dial pad 14 comprises the standard zero through nine, star and pound buttons. The device 5 may include a means for enabling a user to program at least one telephone number for automatic dialing such as a function specific button or series of buttons. In addition, the dial pad 14 may comprise a means for enabling use of the telephone's 10 speakerphone feature such as a button or series of buttons. Further, a button for activating and canceling an alarm notification may be provided. Alternatively, internal software and electronics may be provided to allow the dial pad 14 to aid in such programming. A phone cord or the like is provided for connecting to a standard phone outlet, however, a wireless connection is also possible. The device 5 is powered off of the wall plug power supply but may further comprise a backup battery for retaining programmed telephone numbers and operation during a power outage or similar event.

In another embodiment, the device 5 is programmed to detect an emergency situation, e.g., a fire. The device 5 then calls 9-1-1 to connect with an emergency responder. The emergency responder preferably has a system in place to trace the call back to the place of its origin, e.g., the street address of a home with the fire. Such a device is preferably programmed with the 9-1-1 dial up code at the factory so that it can be a “plug-and-play” system for immediately use right after being taken out of the box by a user.

In alternative embodiments, the device 5 may comprise a variety of different transmission or devices such as a cellular telephone, a personal digital assistant (PDA), computer, or similar such devices. If such devices are used, a GPS or some other locator means is preferably integrated into the device to aid the emergency responder in locating the emergency situation.

The device 5 further comprises an alarm notification device 22 such as a speaker portion or the like provided inside the bottom housing 11b and outside portion on top housing 11a of telephone 10 for audibly indicating the presence of a detected alarm condition. Furthermore, the audible indication of alarm notification device 22 may be configured to provide different tones or messages depending on the type of alarm condition indicated. For instance, if the device 5 detects the presence of smoke, the device 22 may be configured to sound a particular tone whereas if the device 5 detects the presence of excessive heat or carbon monoxide, it may be configured to sound a different one. Alternatively, the device 22 may be configured to audibly sound a particular message such as “Smoke,” “Fire” or “Carbon Monoxide” where the device has detected either smoke or carbon monoxide respectively. Additionally, the alarm notification device 22 may be configured so that when a telephone call is initiated in response to the detection of an alarm condition, the party receiving the telephone call will hear the message sounded by the alarm notification device 22.

In another embodiment of the present invention, the device 5 includes at least one visual indicator or LED 23 on the top or exterior of the housing 11a of the device 5. The LED 23 is configured to illuminate upon the detection of either smoke, excessive heat or carbon monoxide. In one embodiment, the device 5 includes multiple LEDs 23, wherein each LED 23 corresponds to the detection of a different alarm condition such that upon detection of smoke, one LED 23 is illuminated and upon detection of carbon monoxide, the other LED 23 is illuminated, etc. The LEDs 23 may have different flash patterns or colors associated with the alarm condition detected.

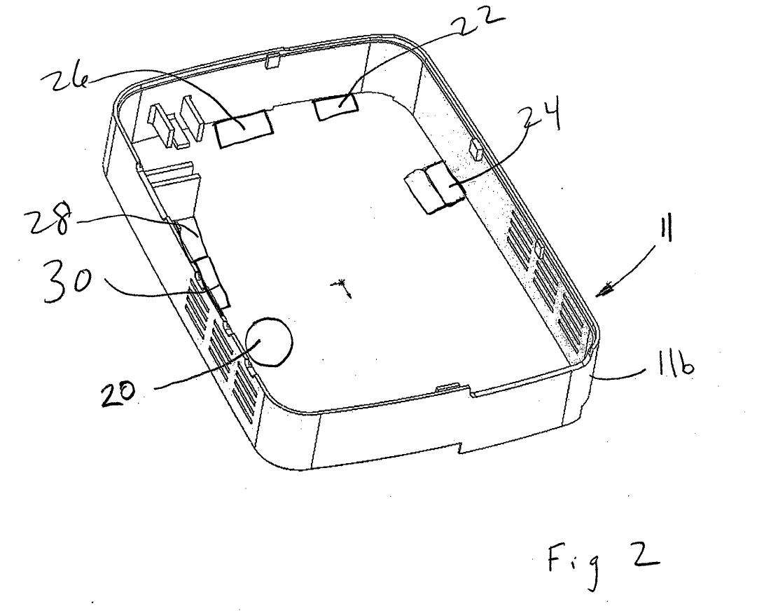

Referring now to FIG. 2, the inside of the device 5 of the present invention is shown wherein at least one detector, e.g., a smoke and carbon monoxide detector 20 is operably mounted in the bottom or interior housing 11b of the device 5. As seen, the housing 11 has vents 13 which allow outside air to flow into the housing interior. In this manner, the detector 20 can sample the air for, e.g., smoke, carbon monoxide. The smoke and carbon monoxide detector 20 is powered by a battery 24, such as an NiCd two or three-cell battery pack or the like. In one embodiment of the present invention, the device 5 may be configured to notify the user when the battery runs low.

In alternative embodiments of the present invention, a temperature detector or sensor or the like may be provided for detecting the ambient temperature near the device 5. The device 5 may be configured, in such embodiments, to send a notification upon the detection of excessive heat and/or cold.

A means for automatically actuating a speakerphone of the telephone 10 and dialing a preprogrammed telephone number in response to the detection of an alarm condition by the smoke and carbon monoxide detector 20, such as a microprocessor control 26 is also provided. The microprocessor 26 operating off of a battery pack is operably connected between the telephone 10 and the detector 20. Alternatively, the microprocessor control 26 may be powered off of a separate power source. The microprocessor 26 receives a signal from the detector 20 upon detection of an alarm condition and then transmits a signal to two isolation switch relays in order to initiate alarm notification as is discussed further below.

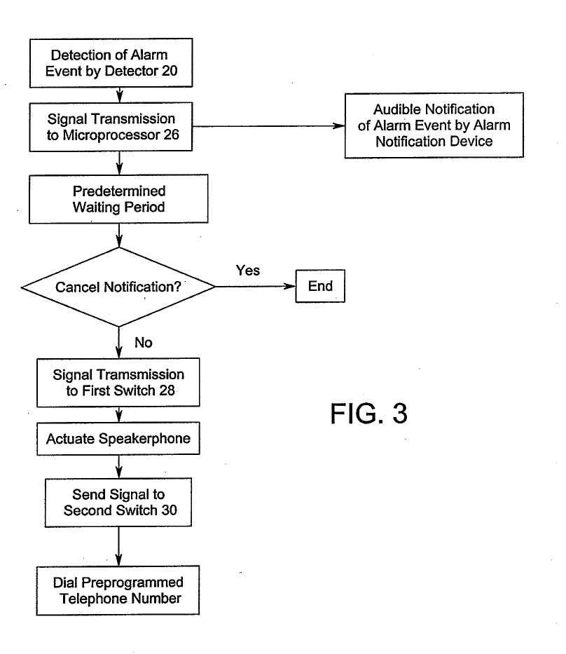

Turning to FIG. 3, a flow chart depicting the operation of one embodiment of the present invention is shown. Upon detection of the presence of an alarm condition, e.g., a sufficient amount of either smoke or carbon monoxide proximal to the device 5, the detector 20 transmits a signal to the microprocessor 26 and an audible and/or visual indication of an alarm condition is transmitted through the alarm notification device 22 and LEDs 23 respectively. After waiting a predetermined amount of time to allow the user to cancel the alarm notification by depressing a button on the dial pad 14, the microprocessor 26 sends a signal to close a first isolation switch 28 in order to actuate the speakerphone button of the telephone 10. Next, a second isolation switch 30 is actuated in order to actuate a button to dial a preprogrammed telephone number such as, for example, 9-1-1 or a user's cellular telephone number. Once a connection is made, the person at the other end is alerted to the presence of an alarm condition by the audible indication discussed previously.

In another embodiment of the present invention, if no one answers the telephone call, the device is configured to automatically hang up the current call and call a secondary preprogrammed telephone number. Alternatively, it can be configured to automatically hang up and redial the same preprogrammed number or dial a multitude of numbers in quick succession to notify multiple parties, e.g., fire department, police department, home owner, etc. In addition, the device may be configured to disconnect the call after a predetermined period of time.

In still another embodiment of the present invention, the device 5 is configured to send an electronic mail alarm notification through a computer operably connected to the device 5 to a predetermined electronic mail address. In addition, a text message or similar such message may be sent to a cellular telephone or PDA device capable of receiving such messages. The device 5 may be programmed to also receive messages from a cell phone or computer to be reset or turned off remotely.

In another embodiment of the present invention, if the telephone is currently in use, the device may be configured to override the condition and independently dial the preprogrammed telephone number.

In use and operation, when the user is ready to use the device for the first time, the user takes the device 5 out of the box and plugs in the proper connectors so that it is ready to use. Preferably the “plug and play” device hooks up like a standard telephone, i.e., into a power outlet and a phone jack. Alternatively, the device 5 may be retrofitted into an existing speakerphone, computer, or other communication system. Alternatively, a 9V, lithium, or some other battery power system may be used. The green light may signal that the unit power is being applied. In one embodiment, the telephone system may have an LCD or LED screen to display instructions as the device is programmed. The LED or LCD screen may also give outputs such as no smoke detected, no carbon monoxide detected, or temperature output.

When the user of the device is ready to leave home, the user programs the device 5 using the keypad attached to the speakerphone. This turns the device on to allow it to begin to detect an emergency situation, for example, a fire, smoke, water, carbon dioxide, or extreme changes in temperature.

Once the device is programmed to detect an alarm situation, the user may go outside of the area where the device is set up. For example, the user may leave to go to work or run errands.

If an emergency situation occurs, such as a fire, smoke and carbon dioxide, it will likely be detected by the device 5. The device 5 is preferably programmed to wait sixty seconds before it calls an emergency preprogrammed number such as 9-1-1. Further, in one preferred embodiment, a red flashing LED light is also triggered to alert anyone near that the device 5 has gone into an emergency mode. An audible alarm preferably also sounds. Preferably, the audible alarm will shut off after a predetermined period of time such as three minutes. Next the device dials 9-1-1 and a digital voice is then played to be audible to the individual who picks up the emergency response line. Such a digital voice may sound the alarm “fire, fire, fire.” The device may also be programmed to give the location of the property where the device is located. Alternatively, some emergency response systems have an emergency locator, which may be tied to a GPS tracker or some other known system to determine the location from which the telephone call was initiated. If the telephone somehow becomes destroyed or goes off the hook, an emergency override system may be initiated. If the device 5 has a camera or visual function, it may be accessed by the call's receiver to verify the emergency notification, for example, actual visual verification of smoke and fire.

The device may then dial a secondary number, such as the homeowner's cell phone number, to repeat the emergency alarm notification. If for some reason it is determined that the emergency notification has been a false alarm, the device 5 may be remotely turned off by using an alarm override code. Of course, the device must be preprogrammed to receive such a code. Alternatively, the alarm can be manually canceled by pressing a button on the phone's touchpad or keypad.

It is intended that the appended claims cover all such additions, modifications, and rearrangements. Expedient embodiments of the present invention are differentiated by the appended claims.

What is claimed is:

1. A device adapted for emergency detection and for automatically dialing a preprogrammed telephone number in response to the detection of an emergency event comprising:
a housing;
a transmitter removably coupled to the housing for use in audible transmissions;
a dial pad fixedly coupled to the housing enabling a user to dial a telephone number, the dial pad further including a means for enabling a user to program at least one telephone number for automatic dialing and a means for enabling use of a speaker;
a smoke and carbon monoxide detector mounted in the housing;
an alarm notification device provided in the housing for audibly announcing the detection of an alarm condition; and
a means for automatically actuating the speaker and dialing a preprogrammed telephone number in response to the detection of an alarm condition by the smoke and carbon monoxide detector.

2. The device of claim 1 wherein the device is selected from a group comprising at least one of a cellular telephone, personal digital assistant (PDA), a conventional telephone, and a computer and the preprogrammed telephone number is 9-1-1.

3. The device of claim 1 further comprising a battery to power the smoke and carbon monoxide detection sensor.

4. The device of claim 3 wherein the battery comprises a multi-cell battery pack.

5. The device of claim 1 further comprising a backup battery for powering the device and retaining the preprogrammed numbers in case of a power outage.

6. The device of claim 1 wherein a pre-recorded audio recording is sounded through the speaker in response to the detection of an alarm condition.

7. The device of claim 1 wherein an audible tone is sounded through the speaker in response to the detection of an alarm condition.

8. The device of claim 1 further comprising at least one LED on the housing of the device for indicating the detection of an alarm condition.

9. The device of claim 3 wherein the device is configured to notify a user when the battery's power runs low.

10. The device of claim 1 further comprising a sensor for detecting at least one of substantially high and substantially low temperatures.

11. The device of claim 5 wherein the device is configured to notify a user when the backup battery's power runs low.

12. A method of alerting persons to the presence of an alarm condition by use of a device comprising the steps of:
detecting the presence of an alarm condition;
announcing the presence of an alarm condition through a speaker provided on the device;
waiting a predetermined amount of time;
actuating a speakerphone;
dialing a preprogrammed telephone number so as to initiate a telephone call; and
deactivating the speakerphone after a predetermined amount of minutes to hang up the call.

13. The method of claim 12 wherein the device redials the preprogrammed telephone number after a predetermined period of time if the call is not answered prior to the deactivating step.

14. The method of claim 12 wherein the device dials a second preprogrammed telephone number after a predetermined period of time if the call is not answered prior to the deactivating step.

15. The method of claim 12 wherein the alarm condition is at least one of smoke, fire, carbon monoxide, substantially high temperature, substantially low temperature, water, and substantially large fluctuations in temperature.

16. An alarm detection and notification device comprising:
a housing;
a receiver and transmitter operably coupled to the housing for initiating audible conversations;
a dial pad operably coupled to the housing;
a detector comprising at least one of a smoke detector, carbon monoxide detector, temperature detector, and water detector operably coupled to the housing; and
a microcontroller operably coupled between the detector and the receiver and dial pad, the microcontroller configured to close a first switch to initiate a telephone call and a second switch to dial a preprogrammed telephone number.

17. The alarm detection and notification device of claim 16 wherein the device comprises at least one of a conventional telephone, a cellular telephone, a PDA, and a computer.

18. The alarm detection and notification device of claim 16 further comprising a battery for providing power to the detector.

19. The alarm detection and notification device of claim 16 further comprising a backup battery for the device.

20. The alarm detection and notification device of claim 16 wherein the detector comprises a combination of at least two of a smoke detector, carbon monoxide detector, temperature detector, and water detector.
